(19) United States
(12) Patent Application Publication
(10) Pub. No.: US 2026/0360298 A1
(43) Pub. Date: Nov. 12, 2026

(54) IMAGE DISPLAY DEVICE AND METHOD BASED ON 3D DISPLAY TECHNOLOGY

(71) Applicant: HUIZHOU TCL MOBILE COMMUNICATION CO., LTD., Huizhou, Guangdong (CN)

(72) Inventors: Lu ZENG, Huizhou, Guangdong (CN); Ke LIN, Huizhou, Guangdong (CN); Yang YU, Huizhou, Guangdong (CN); Pei JIANG, Huizhou, Guangdong (CN)

(73) Assignee: HUIZHOU TCL MOBILE COMMUNICATION CO., LTD., Huizhou, Guangdong (CN)

(21) Appl. No.: 18/997,027

(22) PCT Filed: May 15, 2023
(86) PCT No.: PCT/CN2023/094281

§ 371 Date: Jan. 18, 2025

(30) Foreign Application Priority Data
Jul. 26, 2022 (CN) 202210882811.3

(51) Int. Cl. G09G 3/20; G09G 3/00; G09G 3/3208; G09G 3/34; G09G 3/36

(52) U.S. Cl. CPC G09G 3/2096; G09G 3/003; G09G 3/3406; G09G 3/3208; G09G 3/36; G09G 2320/0209

(57) ABSTRACT

Embodiments of the present application provide an image display device and method based on a 3D display technology. A system comprises: a mainboard control module; a display module; a synchronization control module; and a light angle polarization module. According to the embodiments of the present application, in an ideal state, an instant response can be achieved, and an accurate light valve control timing is given, so that the left eye and the right eye of a user respectively see a correct picture without crosstalk.

This application claims the priority of Chinese Patent Application No. 2022108828113, entitled “IMAGE DISPLAY DEVICE AND METHOD BASED ON 3D DISPLAY TECHNOLOGY”, filed on Jul. 26, 2022, the disclosure of which is incorporated herein by reference in its entirety.

### FIELD OF THE DISCLOSURE

The present disclosure relates to an image display device and method based on 3D display technology.

### BACKGROUND

3D glasses are grouped into active glasses and passive glasses. A frame sequence comprising the left-eye images and right-eye images are alternately shown on a display screen, and a light valve is added between the human eyes and the display screen and used to realize the rotation of the angle of the polarized light emitted by the display screen, so that the polarized light that has been rotated by the light valve is matched with the left and right orthogonal polarizer located on one side of the user's eyes, thereby achieving that turning on and off of the light source of the left eye or the right eye can be controlled. Finally, the left-eye image displayed by the display screen cannot be seen by the right eye, and the right-eye image cannot be seen by the left eye. In this way, the different viewing angles of the left and right eyes are generated on the user, which achieves a 3D display effect.

The core of 3D display technology is that a control signal of a light valve can indicate accurate light valve control timing according to left and right frame information displayed on a display screen in real time (that is, according to whether the displayed image is a left-eye or right-eye image), so that the left and right eyes can see the correct images respectively without crosstalk. In the prior art, it is difficult for a display screen terminal to identify left and right frames according to the received frame sequence (for the screen, only each frame image is displayed). Moreover, in mode of utilizing the operating system running on the CPU on the motherboard to identify the left and right frame states output by the GPU and then separately outputting the left and right frame states by the motherboard, some problems often occur because the operating system running on the CPU on the motherboard is unable to respond in real time to output the left and right frame results. Specifically, this is because the GPU continuously outputs the frame sequence in real time, and the operating system running on the CPU on the motherboard cannot guarantee that real-time frame information (including the position order information of the image frames, such as left or right) can be obtained and output to the synchronization control circuit in real time. To put it simply, because the time point of the operating system running on the CPU to obtain the frame information from the GPU is uncontrollable, it is very likely that the display screen terminal has received the frame sequence, but the operating system running on the CPU is still processing other tasks. When the operating system starts obtaining the frame information from the GPU, the start time point may have been delayed by the time of frame information of several frames, which results in the inability to determine whether the control timing generated by the frame information obtained by the operating system at this time is synchronized with the display sequence of the left-eye and right-eye images to be displayed on the display screen terminal. Another approach is taking a large logic chip, such as a DSP/FPGA, as a synchronous control circuit, which can directly receive the frame sequence generated by the GPU to identify frame information. Although it can solve the problem that the CPU cannot respond in time, this approach has high requirements for power consumption and algorithm of the synchronous control circuit, resulting in an increase in cost.

### SUMMARY

The embodiments of the present disclosure provide an image display method based on 3D display technology. By utilizing an image display device based on 3D display technology provided in the embodiments of the present disclosure, a data interface of a synchronous control module is connected to a display module. While the display module receives a frame sequence transmitted by a motherboard control module, a signal or control timing, which controls an order of turning on and off a left-eye transmission unit and a right-eye transmission unit in a light-angle polarization module (that is, a light valve) to synchronize with the position order of image frames in the frame sequence, can be automatically generated. Thus, an instant response can be achieved in an ideal state, and an accurate light valve control timing can be provided or given, so that the left and right eyes of the user terminal can see the correct images respectively without crosstalk.

One aspect of embodiments of the present disclosure provides an image display device based on 3D display technology to help 3D glasses to achieve an 3D display effect, comprising:
a motherboard control module configured to output a frame sequence comprising left-eye and right-eye image frames;
a display module communicating with the motherboard control module and configured to receive the frame sequence and output a level signal of each image frame according to the frame sequence;
a synchronous control module communicating with the display module and configured to receive the level signal and output control timing synchronized with the frame sequence according to the level signal; and
a light-angle polarization module comprising a left-eye transmission unit and a right-eye transmission unit, wherein the light-angle polarization module is located at an opposite plane of a light source emission side of the display module and communicates with the synchronous control module to receive the control timing to control an order of turning on and off the left-eye transmission unit and the right-eye transmission unit, so that images on left-eye lens and right-eye lens of the 3D glasses are displayed alternately to achieve the 3D effect.

In the image display device according to an embodiment of the present disclosure, the synchronous control module further communicates with the motherboard control module, and the synchronous control module is configured to:
when receiving the level signal transmitted by the display module, generate first frame information corresponding to the level signal, wherein the first frame information is used to indicate left and right frame information of the image frames corresponding to the level signal; and
transmit the first frame information to the motherboard control module for a data verification operation to determine whether the first frame information is correct.

In the image display device according to an embodiment of the present disclosure, the motherboard control module comprises a graphics processing unit and a data processing unit;
wherein the graphics processing unit generates the frame sequence based on a left-eye image frame and a right-eye image frame, and
wherein the data processing unit communicates with the graphics processing unit and the synchronous control module respectively, and the data processing unit is configured to:
when receiving the first frame information, obtain second frame information corresponding to a current image frame output by the graphics processing unit; and
determine whether the first frame information is correct according to the first frame information and the second frame information.

In the image display device according to an embodiment of the present disclosure, the data processing unit is further configured to:
when it is determined that the first frame information is wrong, control the graphics processing unit to swap a position order of image frames used to generate the frame sequence.

In the image display device according to an embodiment of the present disclosure, the display module comprises an LCD display screen or an OLED display screen.

In the image display device according to an embodiment of the present disclosure, when the display module is the LCD display screen, the image display device further comprises:
a backlight module located on an opposite plane of a light source light inlet side of the display module and communicating with the synchronous control module, wherein the backlight module comprises a backlight display unit, and the backlight module is configured to receive the control timing to control an order of turning on and off the backlight display unit.

In the image display device according to an embodiment of the present disclosure, when the synchronous control module receives the level signal transmitted by the display module, the motherboard control module is further configured to:
receive an interrupt signal which is transmitted by the synchronous control module; and
interrupt other operation requests according to the interrupt signal, simultaneously obtain second frame information corresponding to a current frame sequence, and determine whether the first frame information is correct according to the second frame information after the second frame information is obtained.

In the image display device according to an embodiment of the present disclosure, the motherboard control module is further configured to:
record waiting time between a time point of receiving the interrupt signal and a time point of obtaining the second frame information corresponding to the current frame sequence output by the motherboard control module;
record actual time when the second frame information is obtained;
subtract the waiting time from the actual time to obtain theoretical time;
obtain frame information of an image frame corresponding to the theoretical time from an image buffer of the motherboard control module as the second frame information.

In the image display device according to an embodiment of the present disclosure, the motherboard control module is further configured to:
record first time when the interrupt signal is transmitted by the synchronous control module;
record second time when a feedback signal is transmitted to the synchronous control module, wherein the feedback signal is used to indicate a verification result which is output by the motherboard control module after the data verification operation is completed;
subtract the first time from the second time to obtain processing time;
determine whether the obtained second frame information is correct according to the processing time; and
determine whether the synchronous control module is controlled to adjust the control timing according to a determination result.

Correspondingly, another aspect of embodiments of the present disclosure provides an image display method based on 3D display technology for an image display device, to help 3D glasses to achieve a 3D display effect. The image display device comprises a motherboard control module, a display module, a synchronous control module, and light-angle polarization module. The light-angle polarization module comprises a left-eye transmission unit and a right-eye transmission unit. The method comprises steps:
by the motherboard control module, outputting a frame sequence comprising left-eye and right-eye image frames;
by the display module, outputting a level signal of each image frame according to the frame sequence;
by the synchronous control module, outputting control timing synchronized with the frame sequence according to the level signal; and
by the light-angle polarization module, controlling an order of turning on and off the left-eye transmission unit and the right-eye transmission unit according to the control timing, so that the images on the left-eye lens and the right-eye lens of the 3D glasses are displayed alternately to achieve a 3D effect.

According to an embodiment of the present disclosure, the method further comprises:
when receiving the level signal transmitted by the display module, generating first frame information corresponding to the level signal by the synchronous control module, wherein the first frame information is used to indicate left and right frame information of the image frames corresponding to the level signal; and
verifying the first frame information by the motherboard control module to determine whether the first frame information is correct.

According to an embodiment of the present disclosure, the verifying the first frame information by the motherboard control module to determine whether the first frame information is correct comprises:
upon receiving the first frame information, obtaining second frame information corresponding to a current image frame by the motherboard control module; and
determining whether the first frame information is correct according to the first frame information and the second frame information.

According to an embodiment of the present disclosure, the method further comprises:
when it is determined that the first frame information is wrong, swapping a position order of image frames used to generate the frame sequence by the motherboard control module.

According to an embodiment of the present disclosure, before the verifying the first frame information by the motherboard control module to determine whether the first frame information is correct, the method further comprises:
upon receiving the level signal transmitted by the display module, transmitting an interrupt signal to the motherboard control module; and
interrupting other operation requests according to the interrupt signal, simultaneously obtaining second frame information corresponding to a current frame sequence, and determining whether the first frame information is correct according to the second frame information after the second frame information is obtained.

According to an embodiment of the present disclosure, the method further comprises:
recording waiting time between a time point of receiving the interrupt signal and a time point of obtaining the second frame information corresponding to the current frame sequence output by the motherboard control module;
recording actual time when the second frame information is obtained;
subtracting the waiting time from the actual time to obtain theoretical time;
obtaining frame information of an image frame corresponding to the theoretical time from an image buffer of the motherboard control module as the second frame information.

According to an embodiment of the present disclosure, the method further comprises:
recording first time when the interrupt signal is transmitted by the synchronous control module;
recording second time when a feedback signal is transmitted to the synchronous control module, wherein the feedback signal is used to indicate a verification result which is output by the motherboard control module after the data verification operation is completed;
subtracting the first time from the second time to obtain processing time;
determining whether the obtained second frame information is correct according to the processing time; and
determining whether the synchronous control module is controlled to adjust the control timing according to a determination result.

The embodiments of the present disclosure provide an image display method based on 3D display technology. The image display device includes a motherboard control module, a display module communicating with the motherboard control module, a synchronous control module communicating with the display module, and a light-angle polarization module comprising a left-eye transmission unit and a right-eye transmission unit. The motherboard control module outputs a frame sequence comprising left-eye and right-eye image frames. The display module receives the frame sequence and output a level signal of each image frame according to the frame sequence. The synchronous control module receives the level signal and outputs control timing synchronized with the frame sequence according to the level signal. The light-angle polarization module is located at an opposite plane of a light source emission side of the display module and communicates with the synchronous control module to receive the control timing to control an order of turning on and off the left-eye transmission unit and the right-eye transmission unit, so that images on left-eye lens and right-eye lens of the 3D glasses are displayed alternately to achieve the 3D effect. While the display module receives a frame sequence transmitted by a motherboard control module, a signal or control timing, which controls an order of turning on and off a left-eye transmission unit and a right-eye transmission unit in a light-angle polarization module to synchronize with the position order of image frames in the frame sequence, can be automatically generated. Thus, an instant response can be achieved in an ideal state, and an accurate light valve control timing can be provided or given, so that the left and right eyes of the user terminal can see the correct images respectively without crosstalk.

### BRIEF DESCRIPTION OF THE DRAWINGS

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be acquired according to these drawings without creative labor.

FIG. 1 is a schematic diagram of a structure of an image display device of an embodiment of the present disclosure.

FIG. 2 is a flow chart of an image display method of one embodiment of the present disclosure.

FIG. 3 is a flow chart of an image display method of another embodiment of the present disclosure.

FIG. 4 is a flow chart of an image display method of another embodiment of the present disclosure.

FIG. 5 is a flow chart of an image display method of another embodiment of the present disclosure.

Reference signs: 1000, Image display device; 1. 3D glasses; 11. Left-eye lens; 12. Right-eye lens; 2. Motherboard control module; 21. Graphics processing unit; 22. Data processing unit; 3. Display module; 4. Synchronous control module; 5. Light-angle polarization module; 6. Backlight module

### DETAILED DESCRIPTION OF THE PRESENT DISCLOSURE

The technical solution in the embodiment of the present disclosure will be clearly and completely described below in conjunction with the accompanying drawings in the embodiment of the present disclosure. Obviously, the described embodiments are only some embodiments of the present disclosure, not all embodiments. Based on the embodiments in the present disclosure, all other embodiments obtained by a person skilled in the art without creative work fall within the scope of protection of the present disclosure.

In the description of the present disclosure, it is understood that the terms “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, etc., indicate orientations or positional relationships based on the orientations or positional relationships shown in the drawings and are for convenience and simplification of the description only. It is not an indication or implication that the device or element referred to must have a particular orientation, be constructed and operated in a particular orientation and therefore cannot be construed as a limitation on the present disclosure. In addition, the terms “first” and “second” are used for descriptive purposes only and should not be construed as indicating or implying relative importance or implying the number of technical features indicated. Thus, the features that are defined as “first” and “second” may explicitly or implicitly include one or more of the features described. In the description of this application, “plurality” means two or more than two, unless otherwise expressly and specifically qualified.

In the description of the present disclosure, it is noted that, unless otherwise expressly specified and qualified, the terms “mounted”, “connected”, “connected” shall be construed broadly, for example, they may be fixed, detachable, or integrally connected. It can be mechanically connected, electrically connected or can communicate with each other. It can be directly connected or indirectly connected through an intermediate medium, it can be the internal connection of two elements or the interaction relationship between two elements. For those of ordinary skill in the art, the specific meaning of the above terms in the present disclosure may be understood on a case-by-case basis.

In the present disclosure, unless otherwise expressly specified and qualified, the first feature “above” or “below” the second feature may include direct contact between the first and second features, or the first and second features are not in direct contact but through additional feature contact between them. Moreover, the first feature is “above”, “on”, and “over” the second feature includes the first feature directly above and obliquely above the second feature, or simply indicates that the first feature is horizontally higher than the second feature. The first feature is “below”, “beneath”, and “under” the second feature, including the first feature directly below and diagonally below the second feature, or simply indicating that the horizontal height of the first feature is less than that of the second feature.

The disclosure below provides a number of different embodiments or examples to implement the different structures of the present disclosure. In order to simplify the disclosure of the present disclosure, the parts and settings for specific examples are described below. Of course, they are only examples and are not intended to limit the present disclosure. In addition, the present disclosure may repeat the reference numbers and/or reference letters in different examples, and this repetition is for the purpose of simplification and clarity and does not in itself indicate the relationship between the various embodiments and/or settings in question. In addition, the present disclosure provides examples of various specific processes and materials, but those of ordinary skill in the art may be aware of the application of other processes and/or the use of other materials.

The present disclosure is mainly applicable to the field of 3D display technology and is based on 3D glasses. 3D glasses are grouped into active glasses and passive glasses, and the difference between the two groups lies in setting of a light valve. An image display device provided by the present disclosure is described by mainly taking passive glasses as an example. It is understandable that, because the main difference between the active glasses and the passive glasses lies in the setting of a light valve: a light valve of the active glasses is arranged on the glasses, and ae light valve of the passive glasses is attached to the display screen, so the image display device provided by the present disclosure can be extended to the field of active glasses products through structural configuration. Whether it is a terminal device equipped with active glasses or passive glasses, the principle of realizing a 3D effect on a user terminal is to display the frame sequence comprising alternate left-eye and right-eye images on the display screen, to add a light valve between the human eyes and the display screen, and further use the light valve to rotate the polarized light angle emitted by the display screen, so that the polarized light that has been rotated by the light valve is matched with the left and right orthogonal polarizer located on one side of the user's eyes, thereby achieving that turning on and off of the light source of the left eye or the right eye can be controlled. Finally, the left-eye image displayed on the display screen cannot be seen by the right eye, and the right-eye image cannot be seen by the left eye. In this way, the different viewing angles of the left and right eyes are generated on the user terminal, which achieves a 3D display effect.

From the above introduction of 3D display technology, it can be seen that the core of 3D display technology is that a control signal of a light valve can indicate accurate light valve control timing according to left and right frame information displayed by a display screen in real time (that is, according to whether the displayed image is a left-eye or right-eye image), so that the left and right eyes can see the correct images respectively without crosstalk. In the prior art, it is difficult for a display screen terminal to identify left and right frames according to the received frame sequence (for the screen, only each frame image is displayed). Moreover, in the mode of using the operating system running on the CPU on the motherboard to identify the left and right frame states output by the GPU and then separately outputting the left and right frame states by the motherboard, some problems often occur because the operating system running on the CPU on the motherboard is unable to respond in real time to output the left and right frame results. Specifically, this is because the GPU continuously outputs the frame sequence in real time, and the operating system running on the CPU on the motherboard cannot guarantee that real-time frame information (including the position order information of the image frames, such as left or right) can be obtained and output to the synchronization control circuit in real time. To put it simply, because the time node of the operating system running on the CPU to obtain the frame information from the GPU is uncontrollable, it is very likely that the display screen terminal has received the frame sequence, but the operating system running on the CPU is still processing other tasks. When the operating system starts obtaining the frame information from the GPU, the start time point may have been delayed by the time of frame information of several frames, which results in the inability to determine whether the control timing generated by the frame information obtained by the operating system at this time is synchronized with the display sequence of the left-eye and right-eye images to be displayed on the display screen terminal.

Another approach is taking a large logic chip, such as a DSP/FPGA, as a synchronous control circuit, which can directly receive the frame sequence generated by the GPU to identify frame information. Although it can solve the problem that the CPU cannot respond in time, this approach has high requirements for power consumption and algorithm of the synchronous control circuit, resulting in an increase in cost. Therefore, a simpler and more reliable left and right frames recognition in a frame sequence and a synchronization control architecture are provided.

In order to solve the above-mentioned technical problems, the embodiments of the present disclosure provide an image display method based on 3D display technology. By utilizing an image display device based on 3D display technology provided in the embodiments of the present disclosure, a data interface of a synchronous control module is connected to a display module. While the display module receives a frame sequence transmitted by a motherboard control module, a signal or control timing, which controls an order of turning on and off a left-eye transmission unit and a right-eye transmission unit in a light-angle polarization module (that is, a light valve) to synchronize with the position order of image frames in the frame sequence, can be automatically generated. Thus, an instant response can be achieved in an ideal state, and an accurate light valve control timing can be provided or given, so that the left and right eyes of the user terminal can see the correct images respectively without crosstalk.

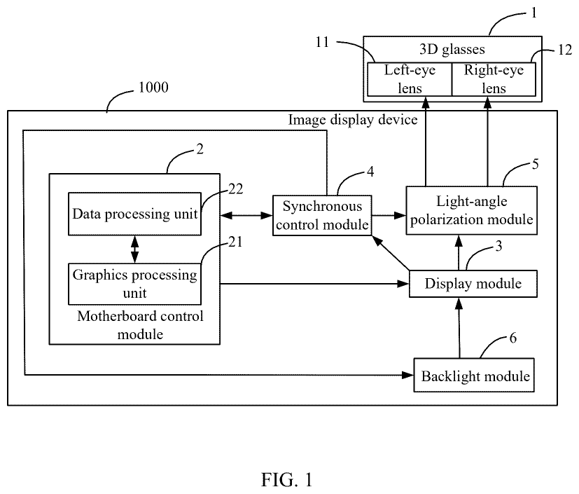

As shown in FIG. 1, an image display device 1000 based on 3D display technology according to an aspect of an embodiment of the present disclosure comprises a motherboard control module 2, a display module 3, a synchronous control module 4, and a light-angle polarization module 5. The motherboard control module 2 is configured to output a frame sequence comprising left-eye and right-eye image frames. The display module 3 is in a communication connection with the motherboard control module 2 and configured to receive the frame sequence and output level signal of each image frame according to the frame sequence. The synchronous control module 4 is in a communication connection with the display module 3 and configured to receive the level signal and output control timing synchronized with the frame sequence according to the level signal. The light-angle polarization module 5 comprises a left-eye transmission unit and a right-eye transmission unit. The light-angle polarization module 5 is located at the opposite plane to a light-source emission side of the display module 3. The light-angle polarization module 5 communicates with the synchronous control module 4 to receive control timing to control the order of turning on and off the left-eye transmission unit and the right-eye transmission unit. The image display device 1000 based on 3D display technology can be integrated in a terminal device. The terminal device specifically refers to a combination of an equipment with a 3D display function and 3D glasses 13D, and the equipment with the 3D display function is, for example, a mobile phone, a tablet computer, a notebook, etc.

The image display device 1000 mainly comprises the motherboard control module 2, the display module 3, the synchronous control module 4, and the light-angle polarization module 5.

The motherboard control module 2 of the image display device 1000 is configured to output the frame sequence that comprises the left-eye and right-eye image frames. Under normal cases, the image frames that the frame sequence comprises presents a pattern of an alternative form “one left one right” or “one right one left” but does not comprise frame information (i.e., position order information of the image frames, such as left or right). For the display module 3, only each frame image comprised in the frame sequence is directly displayed.

The motherboard control module 2 comprises a CPU for processing or running data and a GPU for processing images. The main responsibilities of the CPU and GPU in the embodiment are further explained below.

The display module 3 in the image display device 1000 communicates with the motherboard control module 2 to receive the frame sequence and outputs the level signal of each image frame according to the frame sequence. It should be noted that the level signal refers to a signal represented by a level value, and the level value is divided into a high level “1” and a low level value “0”. A high or low level is a relative concept, for example, 3V is low for 7V, but for 1V is high.

The display module 3 can be an LCD display screen or an OLED display screen or another display screen. It should be noted that because the LCD display screen itself does not have self-luminous characteristics, it is necessary to use an external light source module to achieve the function of displaying images. Therefore, when the display module 3 is an LCD display screen, the image display device 1000 further comprises a backlight module 6 which is located on the opposite plane to the light-source inlet side of the display module 3 and configured to communicate with the synchronous control module 4. The backlight module 6 comprises a backlight display unit. The backlight module 6 is configured to receive the control timing to control an order of turning on and off the backlight display unit. It should be noted that because the images, which are displayed in the process of the deflection of the liquid crystals on the display screen, are unstable, if the backlight display unit is always turned on, it will cause the user to see the contents of the images which are displayed when the liquid crystals are not stable. In this case, the images that the user sees through the 3D glasses are affected by crosstalk. That is, the opening and closing of the shutter of the glasses is not synchronized with the left-eye and right-eye images, so that there is a superposition between the two images seen by the left and right eyes, which results in blurred images and seriously affects the viewing. Therefore, in order to solve this problem, it is necessary to control the synchronization between the order of turning on and off the backlight display unit and the frame sequence by controlling the opening and closing timing of the backlight display unit. That is, the backlight display unit is turned on only when the image of the current image frame is stable, the backlight display unit is turned off when the next frame image frame is transmitted, and the backlight display unit is turned on when the image of the next frame image frame is stable.

The synchronous control module 4 of the image display device 1000 communicates with the display module 3. The synchronous control module 4 s configured to receive the level signal and output the control timing, which is synchronized with the frame sequence, according to the level signal. The synchronous control module 4 generates the control timing of the corresponding backlight and the light valve immediately after receiving the level signal.

For example, the synchronous control module 4 can be an inexpensive chip such as a Field-Programmable Gate Array (FPGA), a Microcontroller Unit (MCU), and a Digital Signal Processing (DSP). In the embodiment, an MCU is taken as an example. After receiving the level signal, the MCU can generate the frame information of the frame sequence by itself and output the control timing. However, because the accuracy rate of the frame information automatically generated by the MCU is difficult to reach 100% (for example, the accuracy rate may be 50%), the MCU may also generate an opposite wrong signal. Thus, in order to solve the above problem, the embodiment will verify the frame information generated by the synchronous control module 4 and determine whether it is necessary to make adjustments according to the verification results, so as to ensure that the corresponding control timing of the subsequent backlight and the light valve is correct.

Specifically, the synchronous control module 4 communicates with the motherboard control module 2 (for example, the synchronous control module 4 is connected to the motherboard control module 2 through an IO port), and the synchronous control module 4 is configured simultaneously to: generate first frame information corresponding to the level signal (the frame information is used to indicate the left and right frame information of the image frame corresponding to the level signal) when receiving the level signal transmitted by the display module 3 and then transmit the first frame information to the motherboard control module 2 for a data verification operation, so as to determine whether the first frame information is correct.

In order to verify the correctness of the first frame information, the embodiment is described based on the main structural compositions of the motherboard control module 2 and the work content shared by each of the main structural compositions

In the embodiment, the motherboard control module 2 comprises a graphics processing unit 21 and a data processing unit 22.

The graphics processing unit 21 generates the frame sequence based on the left-eye image frame and the right-eye image frame.

The data processing unit 22 communicates with the graphics processing unit 21 and the synchronous control module 4 respectively. The data processing unit 22 is configured to: obtain second frame information corresponding to the current image frame output by the graphics processing unit 21 when receiving the first frame information, and determine whether the first frame information is correct based on the first frame information and the second frame information.

In the embodiment, the synchronous control module 4 transmits an interrupt signal to the data processing unit 22 when receiving the level signal transmitted by the display module 3. The interrupt signal is used for controlling the data processing unit 22 to interrupt other operation requests, immediately obtain the second frame information corresponding to the current frame sequence output by the graphics processing unit 21, and determine whether the first frame information is correct according to the second frame information after obtaining the second frame information.

For example, when the second frame information obtained by the data processing unit 22 indicates that the current output of the graphics processing unit 21 is a left-eye image while the identification result generated by the synchronous control module 4 is that the first frame information indicates that the image displayed by the display module is a right-eye image, that is, when the image frame displayed by the display module 3 is adjacent to the image frame that is currently output by the graphics processing unit, the identification result automatically generated by the synchronous control module 4 is correct at this time. When the second frame information obtained by the data processing unit 22 indicates that the current output is a left-eye image while the identification result generated by the synchronization control module 4 is also a left-eye image, the identification result generated by the synchronization control module 4 is wrong at this time, and the graphics processing unit 21 needs to be controlled to swap the position order of the image frames for generating the frame sequence, so that the final frame sequence matches the identification result of the synchronization control module 4.

In the embodiment, the motherboard control module 2 is also configured to record the waiting time between the time point of receiving the interrupt signal from the data processing unit 22 and the time point of obtaining the second frame information corresponding to the current frame sequence output by the graphics processing unit 21, and further record the actual time when the data processing unit 22 obtains the second frame information corresponding to the current frame sequence from the graphics processing unit 21.

In the embodiment, the motherboard control module 2 is also configured to subtract the waiting time from the actual time to obtain theoretical time. The data processing unit 22 obtains the frame information of the image frame corresponding to the theoretical time from the image buffer of the motherboard control module 2 as the second frame information which is used to determine whether the first frame information is correct.

The second frame information is obtained directly from the graphics processing unit 21 by the data processing unit 22, which is different from the graphics processing unit 21 is different, while the data processing unit 22 itself has the function of obtaining the second frame information.

In the embodiment, through the interrupt signal, the motherboard control module can quickly obtain the second frame information, so that whether the first frame information is correct can be determined in time, and when the first frame information is wrong, it is quickly corrected. However, it is understandable that the motherboard control module may deal with cases that the interrupt signal cannot be interrupted, that is, there may be a problem that the motherboard control module cannot respond to the interrupt signal immediately after receiving the interrupt signal. In the scheme that the interrupt signal needs to wait for a response, the display module does not stop the switching display of the left-eye and right-eye images. Thus, the embodiment adopts the scheme, and the theoretical time of receiving the interrupt signal is estimated through the actual time and the waiting time, so as to determine that the image frame output by the graphics processing unit 21 at the theoretical time corresponds to the second frame information, so that the correctness determination for the first frame information is carried out based on the second frame information.

In an example, the data processing unit can also infer the second frame information, which corresponds to the image frame output by the graphics processing unit 21 at the theoretical time, according to the second frame information corresponding to the actual time, the waiting time and the time required for display switching of a single image frame.

The motherboard control module 2 is also configured to record first time when the interrupt signal is transmitted from the synchronous control module 4 and record second time when the data processing unit 22 transmits a feedback signal to the synchronous control module 4. The feedback signal is used to indicate the verification result which is output after the data processing unit 22 completes the data verification operation.

The motherboard control module 2 is also configured to subtract the first time from the second time to obtain processing time and determine whether the second frame information obtained by the data processing unit 22 is correct according to the processing time.

The motherboard control module 2 is further configured to determine whether the synchronous control module 4 is controlled to adjust the control timing according to the determination result.

When the control timing which is automatically generated by the synchronous control module 4 is wrong, the position order of the image frame which is currently output by the graphics processing unit 21 can be adjusted. However, because the wrong control timing caused by synchronous control module 4 has occurred, the user terminal can be caused to see wrong images of several frames. This phenomenon generally appears only when the user just turns on the 3D glasses 13D, and then the images can be displayed stably after completing the adjustment.

The light-angle polarization module 5 of the image display device 1000 comprises the left-eye transmission unit and the right-eye transmission unit. The light-angle polarization module 5 is located at the opposite plane to a light-source emission side of the display module 3. The light-angle polarization module 5 communicates with the synchronous control module 4 to receive the control timing to control the order of turning on and off the left-eye transmission unit and the right-eye transmission unit. Through receiving the control timing, which is output by the synchronous control module 4, by the light-angle polarization module 5 (i.e., the light valve), the order of turning on and off the left-eye transmission unit and the right-eye transmission unit is controlled to synchronize with the position order of the image frames in the frame sequence, so that the left and right eyes of the user terminal can see the correct images respectively without crosstalk.

The embodiments of the present disclosure provide an image display method based on 3D display technology. The image display device includes a motherboard control module 2, a display module 3 communicating with the motherboard control module 2, a synchronous control module 4 communicating with the display module 3, and a light-angle polarization module 5 comprising a left-eye transmission unit and a right-eye transmission unit. The motherboard control module 2 outputs a frame sequence comprising left-eye and right-eye image frames. The display module 3 receives the frame sequence and output a level signal of each image frame according to the frame sequence. The synchronous control module 4 receives the level signal and outputs control timing synchronized with the frame sequence according to the level signal. The light-angle polarization module 5 is located at an opposite plane of a light source emission side of the display module 3 and communicates with the synchronous control module 4 to receive the control timing to control an order of turning on and off the left-eye transmission unit and the right-eye transmission unit, so that images on left-eye lens and right-eye lens of the 3D glasses are displayed alternately to achieve the 3D effect. In the embodiment of the present disclosure, the data interface of the synchronous control module 4 is connected to the display module 3, While the display module 3 receives the frame sequence transmitted by the motherboard control module 2, the control timing, which controls the order of turning on and off the left-eye transmission unit and the right-eye transmission unit in the light-angle polarization module (that is, the light valve) to synchronize with the position order of the image frames in the frame sequence, can be automatically generated. Thus, an instant response can be achieved in an ideal state, and an accurate light valve control timing can be provided or given, so that the left and right eyes of the user terminal can see the correct images respectively without crosstalk.

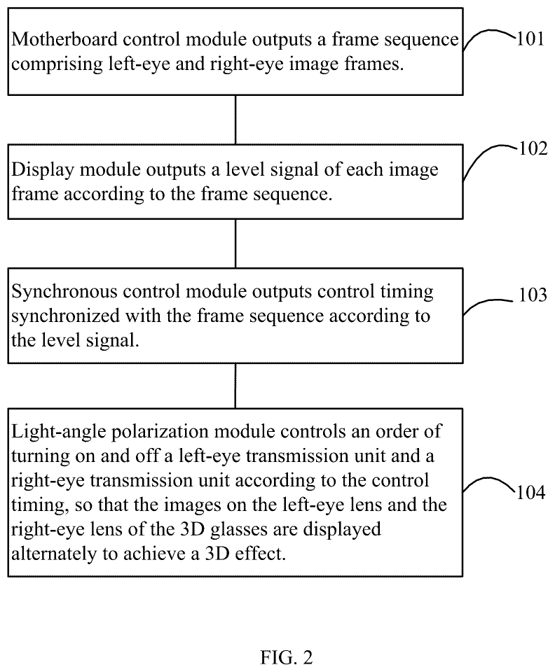

As shown in FIG. 2, an aspect of the embodiment of the present disclosure provides an image display method based on 3D display technology to help 3D glasses to achieve a 3D display effect. The image display device comprises a motherboard control module, a display module, a synchronous control module, and light-angle polarization module. The light-angle polarization module comprises a left-eye transmission unit and a right-eye transmission unit. The method comprises steps 101-109 and step 1010.

Step 101: by the motherboard control module, outputting a frame sequence comprising left-eye and right-eye image frames.

Step 102: by the display module, outputting a level signal of each image frame according to the frame sequence.

It should be noted that the level signal refers to a signal represented by a level value, and the level value is divided into a high level “1” and a low level value “0”. A high or low level is a relative concept, for example, 3V is low for 7V, but for 1V is high.

The display module 3 can be an LCD display screen or an OLED display screen or another display screen. It should be noted that because the LCD display screen itself does not have self-luminous characteristics, it is necessary to use an external light source module to achieve the function of displaying images. Therefore, when the display module 3 is an LCD display screen, the image display device 1000 further comprises a backlight module 6 which is located on the opposite plane to the light-source inlet side of the display module 3 and configured to communicate with the synchronous control module 4. The backlight module 6 comprises a backlight display unit. The backlight module 6 is configured to receive the control timing to control an order of turning on and off the backlight display unit.

Step 103: by the synchronous control module, outputting control timing synchronized with the frame sequence according to the level signal.

For example, the synchronous control module can be an inexpensive chip such as a Field-Programmable Gate Array (FPGA), a Microcontroller Unit (MCU), and a Digital Signal Processing (DSP). In the embodiment, an MCU is taken as an example. After receiving the level signal, the MCU can generate the frame information of the frame sequence by itself and output the control timing. However, because the accuracy rate of the frame information automatically generated by the MCU is difficult to reach 100% (for example, the accuracy rate may be 50%), the MCU may also generate an opposite wrong signal. Thus, in order to solve the above problem, the embodiment will verify the frame information generated by the synchronous control module and determine whether it is necessary to make adjustments according to the verification results, so as to ensure that the corresponding control timing of the subsequent backlight and the light valve is correct.

Specifically, the synchronous control module 4 communicates with the motherboard control module 2 (for example, the synchronous control module 4 is connected to the motherboard control module 2 through an IO port), and the synchronous control module 4 is configured simultaneously to: generate first frame information corresponding to the level signal (the frame information is used to indicate the left and right frame information of the image frame corresponding to the level signal) when receiving the level signal transmitted by the display module 3 and then transmit the first frame information to the motherboard control module 2 for a data verification operation, so as to determine whether the first frame information is correct.

In order to verify the correctness of the first frame information, the embodiment is described based on the main structural compositions of the motherboard control module 2 and the work content shared by each of the main structural compositions

In the embodiment, the motherboard control module 2 comprises a graphics processing unit 21 and a data processing unit 22.

The graphics processing unit 21 generates the frame sequence based on the left-eye image frame and the right-eye image frame.

The data processing unit 22 communicates with the graphics processing unit 21 and the synchronous control module 4 respectively. The data processing unit 22 is configured to: obtain second frame information corresponding to the current image frame output by the graphics processing unit 21 when receiving the first frame information, and determine whether the first frame information is correct based on the first frame information and the second frame information.

In the embodiment, the synchronous control module 4 transmits an interrupt signal to the data processing unit 22 when receiving the level signal transmitted by the display module 3. The interrupt signal is used for controlling the data processing unit 22 to interrupt other operation requests, immediately obtain the second frame information corresponding to the current frame sequence output by the graphics processing unit 21, and determine whether the first frame information is correct according to the second frame information after obtaining the second frame information.

Step 104: by the light-angle polarization module, controlling an order of turning on and off the left-eye transmission unit and the right-eye transmission unit according to the control timing, so that the images on the left-eye lens and the right-eye lens of the 3D glasses are displayed alternately to achieve a 3D effect.

Through receiving the control timing, which is output by the synchronous control module 4, by the light-angle polarization module 5 (i.e., the light valve), the order of turning on and off the left-eye transmission unit and the right-eye transmission unit is controlled to synchronize with the position order of the image frames in the frame sequence, so that the left and right eyes of the user terminal can see the correct images respectively without crosstalk.

In some embodiments, because the data processing unit is not always waiting for the task of determining whether the first frame information transmitted by the synchronization control module is correct (in fact, the data processing unit is engaged in a large number of processing tasks), if the priority of the task of determining whether the first frame information is correct is not specially limited, it is very likely that the data processing unit does not respond in time to determine whether the first frame information is correct, which results in that the degree of the credibility of the authenticity of the determination result made by the data processing unit is not high.

To solve the above problem, before transmitting the first frame of information to the motherboard control module for a data verification operation, the method further comprises the following steps:
Step 105: transmitting an interrupt signal to the data processing unit when the synchronous control module receives the level signal transmitted by the display module, wherein the interrupt signal is used for controlling the data processing unit to interrupt other operation requests;
Step 106: determining whether the current mode is a 3D display mode according to the interrupt signal;
Step 107: immediately obtaining the second frame information corresponding to the current frame sequence output by the graphics processing unit in response to the interrupt signal if the current mode is 3D display mode;
Step 108: after obtaining the second frame information, determining whether the first frame information is correct according to the second frame information;
Step 109: continuously transmitting the frame sequence if the first frame information is correct;
Step 1010: swapping the position order of the image frames used to generate the frame sequence if the first frame information is not correct.

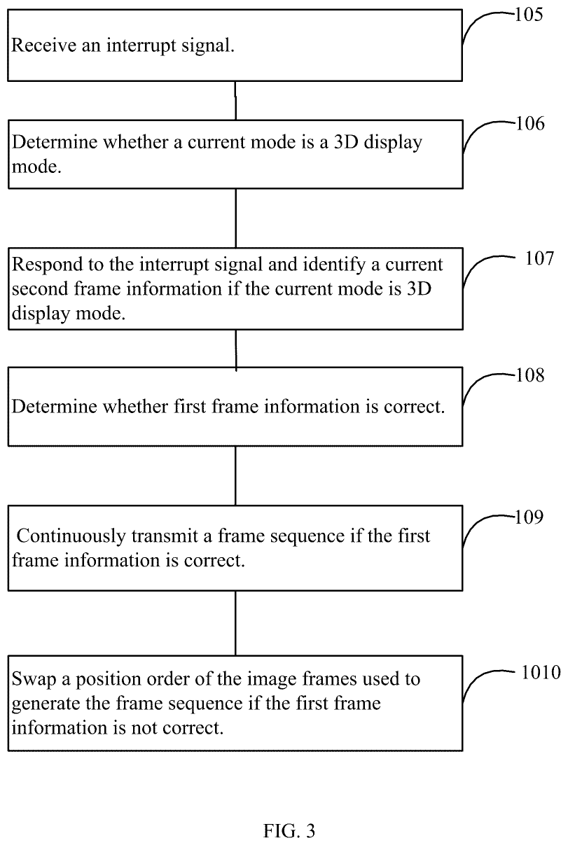

As shown in FIG. 3, in the present embodiment, through transmitting an interrupt signal to the data processing unit at the first time when the synchronization control module receives the level signal, other tasks currently processed by the data processing unit are, that is, the task corresponding to the synchronization control module has the highest priority, so that timely response can be achieved.

In some embodiments, because the data processing unit is not necessarily a real-time system, the data processing unit may be processing other tasks when an interrupt signal enters, resulting in the inability to immediately confirm the identification result of the synchronization control board.

To solve the above problem, the method further comprises the following steps:
Step 1011: receiving an interrupt signal;
Step 1012: determining whether the current mode is a 3D display mode according to the interrupt signal;
Step 1013: recording waiting time between the time point of receiving the interrupt signal from the data processing unit and the time point of obtaining the second frame information corresponding to the current frame sequence output by the motherboard control module if the current mode is the 3D display mode;
Step 1014: recording actual time when the data processing unit obtains second frame information from the graphics processing unit;
Step 1015: subtracting the waiting time from the actual time to obtain theoretical time, and obtaining the frame information of the image frame corresponding to the theoretical time from the image buffer of the motherboard control module as the second frame information;
in Step 1015, the frame information of the image frame corresponding to the theoretical time is the second frame information used to determine whether the first frame information is correct;
Step 1016: determining whether the first frame information is correct;
specifically, whether the first frame information is correct is determined based on the second frame information obtained in Step 1015;
Step 1017: continuously transmitting the frame sequence if the first frame information is correct;
Step 1018: swapping the position order of the image frames used to generate the frame sequence if the first frame information is not correct.

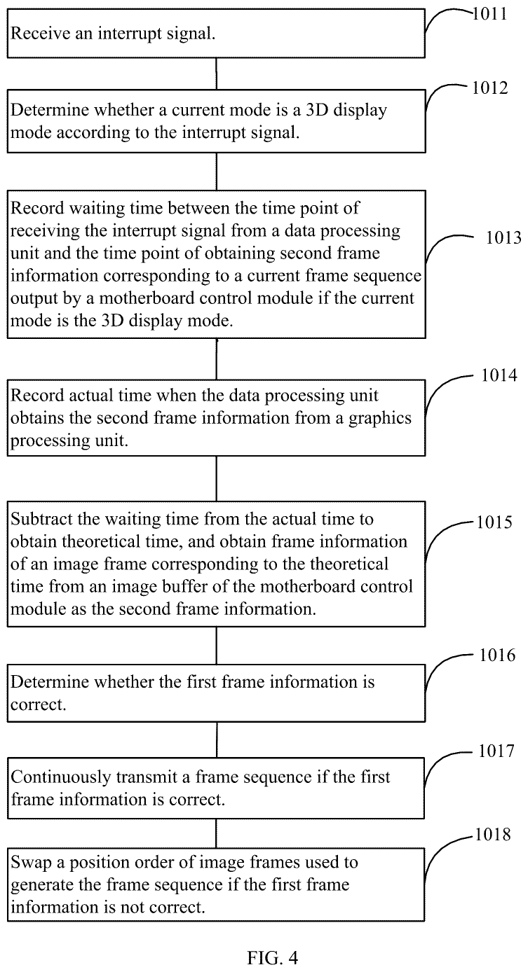

As shown in FIG. 4, in the present embodiment, through utilizing the timestamp function of the data processing unit itself, the waiting time which is generated from the time point when the interrupt signal is received to the time point when the data processing unit starts to have resource for confirming the identification result of the first frame information is recorded. The compensation operation is done according to the waiting time after the second frame information, which is output by the graphics processing unit in real time, is obtained, so that the theoretical time when the interrupt signal from the synchronous control module enters the data processing unit is confirmed. The frame information of the image frame corresponding to the theoretical time is obtained from the image buffer of the motherboard control module as the second frame information, and whether the frame sequence needs to be swapped is determined accordingly.

In some embodiments, the data processing unit may not be able to respond to the interrupt signal in time and further to obtain an accurate waiting time based on the timestamp. That is, the second frame information that the data processing unit obtains under normal conditions is the opposite of the first frame information generated by the synchronization control module. However, because the data processing unit may not be able to obtain an accurate waiting time according to the timestamp, the case where the data processing unit does not obtain the second frame information of the current image frame from the graphics processing unit in time after receiving the interrupt signal may occur, which results in that the image frame corresponding to the second frame information obtained by the data processing unit is not adjacent to the image frame corresponding to the first frame information, or the number of frames therebetween is not an odd multiple of interval, which results in that the adjustment processing result, which is done by the data processing unit when the first frame information is identified as wrong information, is wrong.

In order to solve the above technical problems, the method also includes the following steps:
Step 1019: recording the first time when an interrupt signal is transmitted by the synchronous control module;
Step 1020: receiving the interrupt signal;
Step 1021: determining whether the current mode is a 3D display mode according to the interrupt signal;
Step 1022: waiting for a system response if the current mode is 3D display mode;
Step 1023: confirming the first frame information;
Step 1024: reading an output result of the current sequence;
Step 1025: determining whether the first frame information generated by the synchronization control module is correct;
Step 1026: transmitting a feedback signal to the synchronization control module if the first frame information is correct;
Step 1027: swapping the position order of the image frames used to generate the frame sequence if the first frame information is not correct;
Step 1028: recording the second time when the feedback signal is transmitted to the synchronous control module, subtracting the first time from the second time to obtain processing time, and confirming relationship between the processing time and the multiple of the frame period, wherein the feedback signal is used to indicate the verification result output by the motherboard control module after the data verification operation is completed;
Step 1029: continuing the current timing if the processing time is an even multiple of the frame period;
Step 1030: reversing the control timing of the synchronization control module if the processing time is an odd multiple of the frame period.

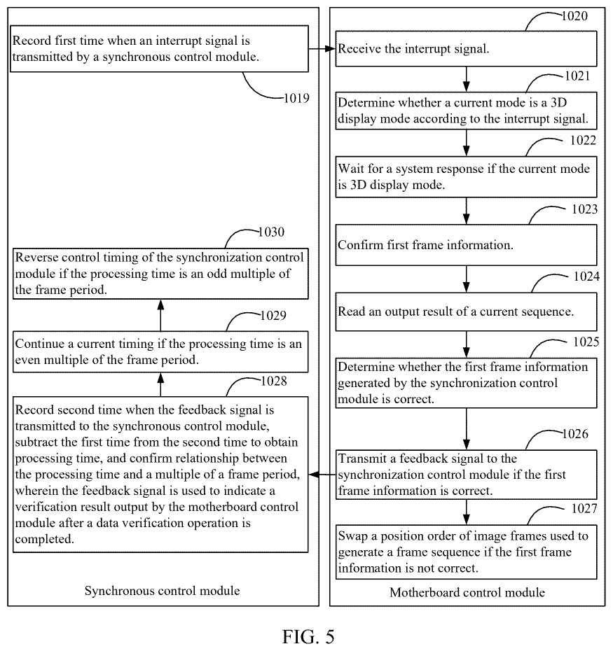

As shown in FIG. 5, after the data processing unit receives the interrupt signal and waits for a certain time, the data processing unit has the resource to obtain the image frames which are transmitted by the graphics processing unit in real time, and the second frame information is compared with the first frame information which is reported by the synchronization control module. If the second frame information is opposite to the first frame information, the positions of the image frames which are output by the graphics processing unit are swapped, and if the comparison result indicates correctness, no further processing is required. After the processing is completed, the data processing unit outputs a feedback signal to inform the synchronization control module of that the confirmation has been completed. Because the synchronization control module has recorded the time when the data processing unit reports the first frame information before, the synchronization control module can determine the processing time of the data processing unit by comparing the above recorded time with the second time when the feedback information, which is given when the processing of the data processing unit is completed, is received. If the processing time is an even multiple of the duration of one frame (for example, 8.333 ms for displaying one frame image on 120 HZ), the processing result of the data processing unit is correct, and if the calculated waiting time is an odd multiple of the duration of one frame, the processing result of the data processing unit is wrong, and the aforementioned control timing is adjusted by the synchronization control module (the order of the left and right frames is alternated once).

All the above-mentioned optional technical solutions may be arbitrarily combined to form an optional embodiment of the present disclosure, and will not be repeated herein.

In specific implementation, the present disclosure is not limited by the order of performing the steps described, and some steps may be carried out in other sequences or at the same time without conflict.

The embodiments of the present disclosure proposes a method of displaying images based on 3D display technology comprising: outputting a frame sequence comprising left-eye and right-eye image frames by the motherboard control module; receiving the frame sequence and outputting a level signal of each image frame according to the frame sequence by the display module; controlling, by the light-angle polarization module, an order of turning on and off the left-eye transmission unit and the right-eye transmission unit according to the control timing, so that images on left-eye lens and right-eye lens of the 3D glasses are displayed alternately to achieve the 3D effect. In the embodiments of the present disclosure, a data interface of a synchronous control module is connected to a display module. While the display module receives a frame sequence transmitted by a motherboard control module, a signal or control timing, which controls an order of turning on and off a left-eye transmission unit and a right-eye transmission unit in a light-angle polarization module to synchronize with the position order of image frames in the frame sequence, can be automatically generated. Thus, an instant response can be achieved in an ideal state, and an accurate light valve control timing can be provided or given, so that the left and right eyes of the user terminal can see the correct images respectively without crosstalk.

In the above embodiments, the descriptions of each embodiment have their own emphasis, and the part that is not detailed in a certain embodiment may be referred to the relevant descriptions of other embodiments.

The above embodiments of the present disclosure are described in detail, and the principle and embodiment of the present disclosure are elaborated in this article by applying specific examples, and the description of the above embodiments is only used to help understand the technical scheme of the present disclosure and its core ideas; A person skilled in the art should understand that he may still modify the technical solutions recorded in the foregoing embodiments, or replace some of the technical features therein; And these modifications or substitutions do not make the essence of the corresponding technical solutions out of the scope of the technical solutions of the embodiments of the present disclosure.

1. An image display device based on 3D display technology used to help 3D glasses to achieve a 3D display effect, comprising:
a motherboard control module configured to output a frame sequence comprising left-eye and right-eye image frames;
a display module communicating with the motherboard control module and configured to receive the frame sequence and output a level signal of each image frame according to the frame sequence;
a synchronous control module communicating with the display module and configured to receive the level signal and output control timing synchronized with the frame sequence according to the level signal; and
a light-angle polarization module comprising a left-eye transmission unit and a right-eye transmission unit, wherein the light-angle polarization module is located at an opposite plane of a light source emission side of the display module and communicates with the synchronous control module to receive the control timing to control an order of turning on and off the left-eye transmission unit and the right-eye transmission unit, so that images on left-eye lens and right-eye lens of the 3D glasses are displayed alternately to achieve the 3D effect.

2. The image display device of claim 1, wherein the synchronous control module further communicates with the motherboard control module, and the synchronous control module is configured to:
when receiving the level signal transmitted by the display module, generate first frame information corresponding to the level signal, wherein the first frame information is used to indicate left and right frame information of the image frames corresponding to the level signal; and
transmit the first frame information to the motherboard control module for a data verification operation to determine whether the first frame information is correct.

3. The image display device of claim 2, wherein the motherboard control module comprises a graphics processing unit and a data processing unit;
wherein the graphics processing unit generates the frame sequence based on a left-eye image frame and a right-eye image frame, and
wherein the data processing unit communicates with the graphics processing unit and the synchronous control module respectively, and the data processing unit is configured to:
when receiving the first frame information, obtain second frame information corresponding to a current image frame output by the graphics processing unit; and
determine whether the first frame information is correct according to the first frame information and the second frame information.

4. The image display device of claim 3, wherein the data processing unit is further configured to:
when it is determined that the first frame information is wrong, control the graphics processing unit to swap a position order of image frames used to generate the frame sequence.

5. The image display device of claim 1, wherein the display module comprises an LCD display screen or an OLED display screen.

6. The image display device of claim 5, wherein when the display module is the LCD display screen, the image display device further comprises:
a backlight module located on an opposite plane of a light source light inlet side of the display module and communicating with the synchronous control module,
wherein the backlight module comprises a backlight display unit, and the backlight module is configured to receive the control timing to control an order of turning on and off the backlight display unit.

7. The image display device as claimed in claim 2, wherein when the synchronous control module receives the level signal transmitted by the display module, the motherboard control module is further configured to:
receive an interrupt signal which is transmitted by the synchronous control module; and
interrupt other operation requests according to the interrupt signal, simultaneously obtain second frame information corresponding to a current frame sequence, and determine whether the first frame information is correct according to the second frame information after the second frame information is obtained.

8. The image display device of claim 7, wherein the motherboard control module is further configured to:
record waiting time between a time point of receiving the interrupt signal and a time point of obtaining the second frame information corresponding to the current frame sequence output by the motherboard control module;
record actual time when the second frame information is obtained;
subtract the waiting time from the actual time to obtain theoretical time;
obtain frame information of an image frame corresponding to the theoretical time from an image buffer of the motherboard control module as the second frame information.

9. The image display device of claim 8, wherein the motherboard control module is further configured to:
record first time when the interrupt signal is transmitted by the synchronous control module;
record second time when a feedback signal is transmitted to the synchronous control module, wherein the feedback signal is used to indicate a verification result which is output by the motherboard control module after the data verification operation is completed;
subtract the first time from the second time to obtain processing time;
determine whether the obtained second frame information is correct according to the processing time; and
determine whether the synchronous control module is controlled to adjust the control timing according to a determination result.

10. The image display device of claim 1, wherein the synchronous control module is a Field Programmable Gate Array (FPGA), a Microcontroller unit (MCU), a digital signal processor (DSP).

11. The image display device of claim 1, wherein the motherboard control module comprises a central processing unit (CPU) for data running processing and a graphical processing unit (GPU) for image processing.

12. A method of displaying images based on 3D display technology, applied in an image display device which comprises a motherboard control module, a display module, a synchronous control module, and a light-angle polarization module comprising a left-eye transmission unit and a right-eye transmission unit, to help 3D glasses to achieve a 3D display effect, the method comprising:
outputting a frame sequence comprising left-eye and right-eye image frames by the motherboard control module;
receiving the frame sequence and outputting a level signal of each image frame according to the frame sequence by the display module;
outputting control timing synchronized with the frame sequence in response to the level signal by the synchronous control module; and
controlling, by the light-angle polarization module, an order of turning on and off the left-eye transmission unit and the right-eye transmission unit according to the control timing, so that images on left-eye lens and right-eye lens of the 3D glasses are displayed alternately to achieve the 3D effect.

13. The method of claim 12, further comprising:
when receiving the level signal transmitted by the display module, generating first frame information corresponding to the level signal by the synchronous control module, wherein the first frame information is used to indicate left and right frame information of the image frames corresponding to the level signal; and
verifying the first frame information by the motherboard control module to determine whether the first frame information is correct.

14. The method of claim 13, wherein the verifying the first frame information by the motherboard control module to determine whether the first frame information is correct comprises:
upon receiving the first frame information, obtaining second frame information corresponding to a current image frame by the motherboard control module; and
determining whether the first frame information is correct according to the first frame information and the second frame information.

15. The method of claim 14, further comprising:
when it is determined that the first frame information is wrong, swapping a position order of image frames used to generate the frame sequence by the motherboard control module.

16. The method of claim 14, wherein before the verifying the first frame information by the motherboard control module to determine whether the first frame information is correct, the method further comprises:
upon receiving the level signal transmitted by the display module, transmitting an interrupt signal to the motherboard control module; and
interrupting other operation requests according to the interrupt signal, simultaneously obtaining second frame information corresponding to a current frame sequence, and determining whether the first frame information is correct according to the second frame information after the second frame information is obtained.

17. The method of claim 16, further comprising:
recording waiting time between a time point of receiving the interrupt signal and a time point of obtaining the second frame information corresponding to the current frame sequence output by the motherboard control module;
recording actual time when the second frame information is obtained;
subtracting the waiting time from the actual time to obtain theoretical time;
obtaining frame information of an image frame corresponding to the theoretical time from an image buffer of the motherboard control module as the second frame information.

18. The method of claim 17, further comprising:
recording first time when the interrupt signal is transmitted by the synchronous control module;
recording second time when a feedback signal is transmitted to the synchronous control module, wherein the feedback signal is used to indicate a verification result which is output by the motherboard control module after the data verification operation is completed;
subtracting the first time from the second time to obtain processing time;
determining whether the obtained second frame information is correct according to the processing time; and
determining whether the synchronous control module is controlled to adjust the control timing according to a determination result.

19. The method of claim 12, wherein the synchronous control module is a Field Programmable Gate Array (FPGA), a Microcontroller unit (MCU), a digital signal processor (DSP).

20. The method of claim 12, wherein the motherboard control module comprises a central processing unit (CPU) for data running processing and a graphical processing unit (GPU) for image processing.
